(19) United States
(12) Patent Application Publication
(10) Pub. No.: US 2014/0258375 A1
(43) Pub. Date: Sep. 11, 2014

(54) SYSTEM AND METHOD FOR LARGE OBJECT CACHE MANAGEMENT IN A NETWORK

(71) Applicant: LSI CORPORATION, San Jose, CA (US)

(72) Inventor: Robert J. Munoz, Round Rock, TX (US)

(73) Assignee: LSI Corporation, San Jose, CA (US)

(21) Appl. No.: 13/855,804

(22) Filed: Apr. 3, 2013

Related U.S. Application Data
(60) Provisional application No. 61/775,923, filed on Mar. 11, 2013.

(51) Int. Cl. G06F 15/167

(52) U.S. Cl. CPC G06F 15/167
USPC 709/203

(57) ABSTRACT

Aspects of the disclosure pertain to a system and method for large object cache management in a network. A proxy server of the present disclosure implements a token-based policing mechanism via a cache tracking table to evaluate objects for potential inclusion in a cache controlled by the proxy server and to age-out objects already stored in the cache. Use of the tracking table and token-based policing mechanism by the proxy server promoting efficient usage of caching resources and promotes efficient handling of client requests for large data objects, such as video files.

### CROSS-REFERENCE TO RELATED APPLICATIONS

This application claims priority to U.S. Provisional Application No. 61/775,923 filed on Mar. 11, 2013, entitled: “A System and Method for Large Object Cache Management in a Network”, which is hereby incorporated by reference in its entirety.

### FIELD OF THE INVENTION

The present disclosure relates to the field of network systems and particularly to a system and method for large object cache management in a network.

### BACKGROUND

In networks, resources and information are shared by computers which are interconnected by communication channels. One of the resources that is often shared over networks (e.g., mobile networks) is video content (e.g., mobile video, over-the-top video). Mobile video is a significant contributor to the overall traffic burden in many networks.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter in any manner

Aspects of the disclosure pertain to a system and method for large object cache management in a network.

### BRIEF DESCRIPTION OF THE FIGURES

The detailed description is described with reference to the accompanying figures:

FIG. 1 is an example conceptual block diagram schematic of a system (e.g., network) in accordance with an exemplary embodiment of the present disclosure; and

FIG. 2 is a flow chart illustrating a method of operation of a proxy server of the network, in accordance with an exemplary embodiment of the present disclosure.

### WRITTEN DESCRIPTION

Embodiments of the invention will become apparent with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. Among other things, the features of the disclosure can be facilitated by methods, devices, and/or embodied in articles of commerce. The following detailed description is, therefore, not to be taken in a limiting sense.

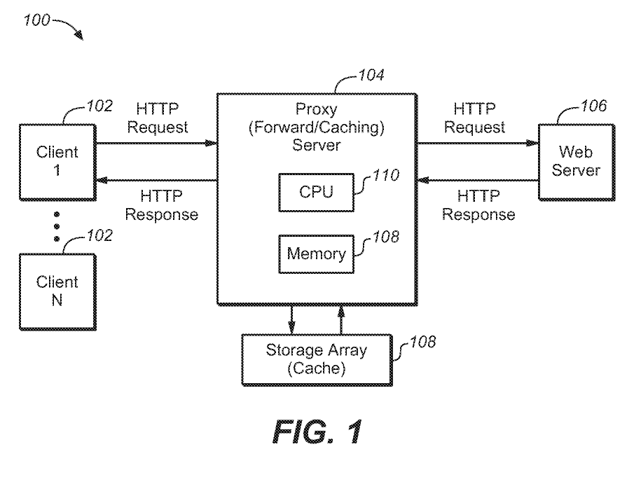

Referring to FIG. 1, a network 100 is shown. In embodiments, the network 100 is a collection of computers and other hardware interconnected by communication channels that allow sharing of resources and information (e.g., video files, mobile video). In embodiments, the network 100 is a wireless network (e.g., mobile network). In embodiments, the network 100 includes one or more clients 102. In embodiments, the client 102 is configured for accessing a service made available by a server. In embodiments, the client 102 is hardware or software of a computer system. In embodiments in which the client 102 is software, it is a computer program that sends a request to another computer program. In further embodiments, the client 102 is a computer system that runs the client software. In still further embodiments, the client 102 refers to a user of the client software.

In embodiments, the network 100 includes a server 104. In embodiments, the client(s) 102 are configured for being connected to (e.g., communicatively coupled with) the server 104. In embodiments, the server 104 is a proxy server (e.g., local server). In embodiments, the proxy server 104 is a server (e.g., a computer system (hardware) or an application) that acts as an intermediary for requests from clients 102 seeking resources from other servers. In embodiments, the client 102 is configured for connecting to the proxy server 104 and requesting some service, such as a file, connection, web page or other resource available from a different server 106 of the network 100. In embodiments, the proxy server 104 is configured for evaluating the request. In embodiments, the different server 106 of the network 100 is a web server, while the proxy server 104 is a web proxy, which is configured for facilitating access to content on the World Wide Web. In embodiments, the web server 106 is hardware (e.g., a computer) or software (e.g., computer application) that helps to deliver Web content that can be accessed through the Internet. For example, the web server 106 is configured for delivering web pages on the request to the client 102 using Hypertext Transfer Protocol (HTTP). In embodiments, server 106 is a web server, a content delivery network (CDN) server, and/or a higher level cache server.

In embodiments, the proxy server 104 is connected to and/or includes a memory and/or physical storage devices. In embodiments, the memory and/or storage devices include(s) a cache 108. In embodiments, the cache 108 is connected to (e.g., included in) the proxy server 104. In embodiments, the cache 108 is a component that transparently stores data (e.g., objects, object data) so that future requests for that data can be served faster. In embodiments, the cache 108 is used for temporary storage of data likely to be used again. Caching is valuable in that it reduces network bandwidth and improves the quality of experience for subscribers. In embodiments, the proxy server 104 is configured for speeding up access by the client 102 to requested resources by utilizing caching (e.g., storing data in the cache). For example, the proxy server 104 is configured for caching web pages received from the web server 106. By keeping local copies of frequently requested resources, caching by the proxy server 104 promotes reduced upstream bandwidth usage. In embodiments, the proxy server 104 is a forwarding/caching server. In embodiments, the proxy server 104 includes a processor 110 (e.g., a central processing unit (CPU)). In embodiments, the CPU 110 is hardware within a computer system (e.g., within the proxy server 104) that carries out the instructions of a computer program by performing the basic arithmetical, logical and input/output operations of the proxy server 104. In embodiments, the proxy server 104 communicates with the web server/CDN server/higher-level cache server 106 or other network elements to update them about items the proxy server 104 is serving from the cache 108 so that billing, view counts, etc., can be properly tracked. In further embodiments, the proxy server 104 provides real-time video transcoding or other application-specific transformations of cached or fetched data to serve the data to clients in a format most suitable for their consumption.

In embodiments, the proxy server 104 is configured for creating and maintaining (e.g., updating) a cache tracking table in the memory 108. In embodiments, the cache tracking table includes a list of entries corresponding to objects that are currently stored in the cache 108. In further embodiments, the cache tracking table includes a list of entries corresponding to objects that will possibly be stored in the cache in the future. In embodiments, the cache tracking table provides updated information indicating which objects (or portion of the objects) having corresponding entries in the table are currently stored in the cache 108. In still further embodiments, each entry listed in the cache tracking table includes a token bucket corresponding to the object associated with that entry. In embodiments, when retrieval of an object from the network 100 is initially requested by one of the clients 102 of the network, an entry corresponding to the requested object is created in the cache tracking table, a token bucket corresponding to that object is created in the cache tracking table, and a configurable number of tokens are added to the token bucket corresponding to that object. After being initially requested, each time that object is again requested by any of the clients 102 of the network, the entry corresponding to that object in the cache tracking table is updated by adding a configurable number of tokens to the token bucket associated with that object in the cache tracking table.

In embodiments, proxy server 104 is configured for updating the cache tracking table by removing a configurable number of tokens from the token buckets associated with each object after expiration of a configurable time period. For example, the cache tracking table is periodically updated such that, each time the configurable time period elapses, the configurable number of tokens is removed from the token buckets associated with the objects.

In embodiments, the proxy server 104 is configured for adding the tokens to and/or removing the tokens from the token buckets of entries in the cache tracking table based upon the size of the object associated with the given entry. Therefore, in embodiments, the proxy server 104 is configured for adding fewer tokens on a per request basis to token buckets of entries associated with larger objects than it adds to token buckets of entries associated with smaller objects. Further, in embodiments, each time the configurable time period described above elapses, the proxy server 104 is configured for removing more tokens from token buckets of entries associated with larger objects than it removes from token buckets associated with smaller objects.

In embodiments, the proxy server 104 is configured for monitoring (e.g., continuously monitoring) the number of tokens which are included in the token buckets of the object entries in the cache tracking table. Based upon this monitoring, the proxy server 104 determines (e.g., evaluates) the objects associated with those entries for their potential inclusion in the cache, continued inclusion in the cache, or removal from the cache. In embodiments, when monitoring indicates that a number of tokens included in a token bucket of an entry associated with an object is above a pre-determined threshold value, if the object is not already stored in the cache, the proxy server 104 is configured for causing the object to be stored in the cache 108. In embodiments, when monitoring indicates that the number of tokens included in the token bucket of the entry associated with the object is above the pre-determined threshold value, if the object is already stored in the cache, the proxy server 104 is configured for causing the object to continue to be stored in the cache 108. In embodiments, when monitoring indicates that the number of tokens included in the token bucket of the entry associated with the object is above the pre-determined threshold value, if the object is not already stored in the cache, but there is not enough room in the cache at that time to store the object (e.g., due to the presence of other objects in the cache), the proxy server 104 is configured for updating the cache tracking table to include an indication (e.g., marker, designation) that the object is eligible to be stored in the cache once sufficient storage space in the cache becomes available (as long as the token count for the entry associated with that object is still above the threshold value/number), this marker being a storage-eligible marker. In embodiments, if during subsequent monitoring, the number of tokens associated with the object having the storage-eligible marker decreases to or below the threshold value and the object hasn't yet been stored in the cache 108, the storage-eligible marker will be removed from the entry for that object.

In embodiments, when a number of tokens included in a token bucket of an entry associated with an object stored in the cache 108 is at or below a threshold number of tokens (e.g., has zero tokens or a negative number of tokens), the proxy server 104 updates the cache tracking table to include an indication (e.g., marker, designation) that the object associated with that entry is eligible for replacement in the cache 108, this indication being a replacement-eligible marker. In embodiments, as storage space in the cache 108 becomes increasingly limited (e.g., gets closer to becoming or becomes full) due to more objects being stored in the cache 108, storage space in the cache allocated to objects associated with the entries having replacement-eligible markers is re-allocated by the proxy server 104 for storing objects associated with entries having storage-eligible markers. Thus, in this way, objects which are seldom (e.g., less frequently) requested are aged out. In embodiments, the token-based aging mechanism for managing efficient use of scarce cache resources can be used in addition to whatever age out timing might be required for the content being stored based upon the attributes of that content (e.g., a video clip might be regularly updated so the cache only serves a retrieved version for a limited period of time before needing to fetch the revised version from somewhere upstream in the network

In embodiments, the above-described token addition and removal mechanism implemented by the proxy server 104 promotes efficient use of caching resources by prioritizing objects for storage in the cache 108 based upon the frequency with which those objects are requested by clients 102. For example, entries in the cache tracking table corresponding to objects which are seldom requested will generally have fewer tokens in their token buckets compared to entries corresponding to frequently requested objects. Thus, the proxy server 104 is more likely to store the frequently requested objects in the cache 108, rather than less frequently (e.g., rarely) requested objects.

Further, the above-described token addition and removal mechanism is weighted to account for the higher cost (in terms of cache storage space and resources) associated with storing larger objects compared with smaller objects. For example, fewer tokens are added, on a per request basis, to entries associated with larger objects than are added to entries associated with small objects. Further, more tokens are removed, per each configurable time period elapsed, from entries associated with larger objects than are removed from entries associated with small objects. This weighted mechanism for adding and removing tokens helps to ensure that larger objects will be cached if they are requested often enough (e.g., proportionately more often than smaller objects) to offset (e.g., justify) the cost associated with storing them.

In embodiments, as mentioned above, when the cache 108 is close to being full or is full (e.g., its object storing capacity is close to being exhausted or is exhausted), the proxy server 104 is configured for re-claiming (e.g., re-allocating) storage space of the cache 108. For example, at a given point in time during monitoring, the proxy server 104 is configured for re-claiming (re-allocating) cache storage space used by objects having entries with low token counts at that point in time to instead store objects having higher token counts at that point in time. In this way, the proxy server 104 prioritizes objects for storage in the cache 108 based on the number of tokens (e.g., token count) in the cache tracking table entries associated with the objects.

In embodiments, the proxy server 104 is configured for utilizing the cache tracking table to track how often only a portion of an object is requested as compared to the entire object. In embodiments, one or more entries in the cache tracking table include data which indicates how often a portion (e.g., a beginning portion) of the object (e.g., video content) associated with the entry is requested compared to how often the entire object associated with the entry is requested. In embodiments, the entry includes a separate/additional token bucket, the separate token bucket being associated with a portion of the object, to which tokens are added and from which tokens are removed, the tokens being added to the separate token bucket when only a portion of the object associated with the entry is requested. The proxy server 104 is configured for utilizing this data (e.g., comparing the amount of requests and token counts) to evaluate/determine whether it would be more efficient (in terms of caching resources) to cache the whole object or to cache only the beginning portion of the object. In embodiments, a configurable threshold number of tokens is required to be present in the separate token bucket associated with the portion of the object in order for just the portion of the object to be stored in the cache.

In embodiments, as more objects occupy the cache 108 (e.g., as the cache becomes more full), the proxy server 104 is configured for causing the threshold token number required for qualifying an object (or portion of an object) for storage in the cache to be increased. Further, as more objects occupy the cache 108 (e.g., as the cache becomes more full), the proxy server 104 is configured for causing the number of tokens which are removed after each configurable time period elapses to be increased, thereby allowing for the aging out stored objects at a faster rate when cache resources become scarce. These features allow for potentially scarce cache resources to be allocated to the subset of content that will most effectively offload the network.

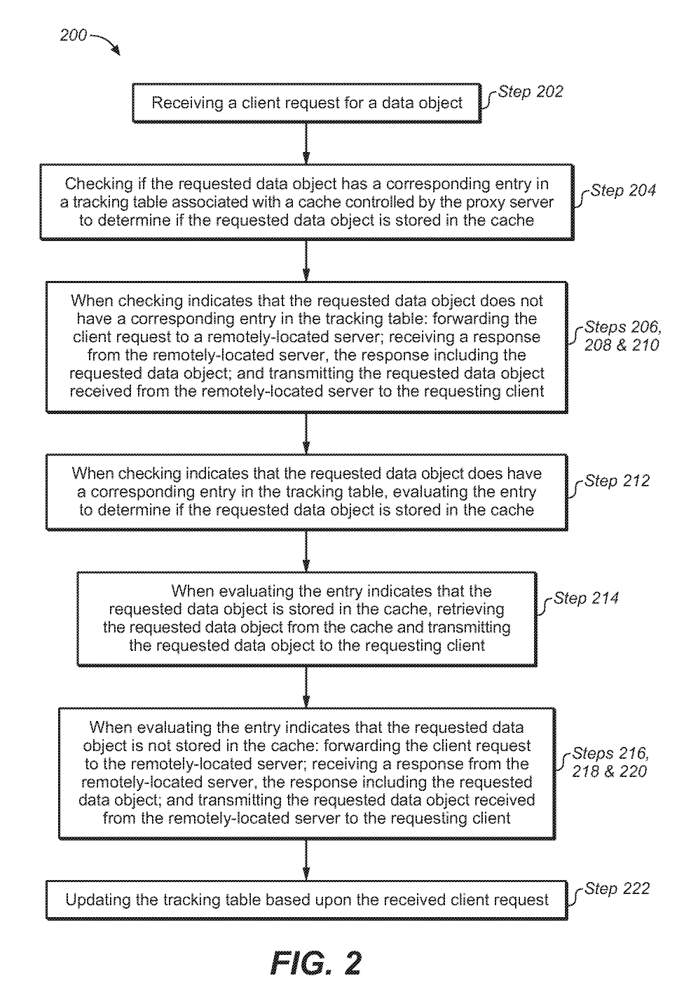

FIG. 2 is a flowchart illustrating a method of operation of the proxy server 104 described above. In embodiments, the method 200 includes a step of receiving a client request for a data object (Step 202). For example, the request is received by the proxy server 104 from the client 102 and is a HTTP request for a data object, such as a video file.

In embodiments, the method 200 further includes a step of checking if the requested data object has a corresponding entry in a tracking table associated with a cache controlled by the proxy server to determine if the requested data object is stored in the cache (Step 204).

In embodiments, the method 200 further includes a step of, when checking indicates that the requested data object does not have a corresponding entry in the tracking table, forwarding the client request to a remotely-located server (Step 206), receiving a response from the remotely-located server, the response including the requested data object (Step 208), and transmitting the requested data object received from the remotely-located server to the requesting client (Step 210). For example, if the proxy server 104 determines that there is not an entry for the requested data object in the cache tracking table, the proxy server 104 can deduce that the requested data object is not stored in the cache 108, and can forward the request to a remotely-located server (e.g., a webserver 106), so that the webserver 106 can fulfill the request.

In embodiments, the method 200 further includes a step of, when checking indicates that the requested data object does have a corresponding entry in the tracking table, evaluating the entry to determine if the requested data object is stored in the cache (Step 212). In embodiments, when evaluating the entry indicates that the requested data object is stored in the cache, retrieving the requested data object from the cache and transmitting the requested data object to the requesting client (Step 214). In embodiments, when evaluating the entry indicates that the requested data object is not stored in the cache, the method 200 further includes the steps of forwarding the client request to the remotely-located server (Step 216), receiving a response from the remotely-located server, the response including the requested data object (Step 218), and transmitting the requested data object received from the remotely-located server to the requesting client (Step 220). For example, the response received by the proxy server 104 from the web server 106 is a HTTP response which includes the data object (e.g., a video file).

In further embodiments, the method 200 further includes a step of updating the tracking table based upon the received client request (Step 222). For example, if no entry corresponding to the requested object was present in the table, updating the tracking table would include creating the entry and adding tokens to a token basket associated with the entry. Alternatively, if an entry corresponding to the requested object was already present in the table, updating the tracking table would include adding tokens to the token basket associated with the entry.

In embodiments, the herein described cache tracking mechanism is well-suited for use close to an edge of a network. Further, the herein described cache tracking mechanism is well-suited to be used at either an eNodeB (e.g., E-UTRAN Node B, Evolved Node B) or a Radio Network Controller (RNC).

It is to be noted that the foregoing described embodiments may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the embodiments described herein may be conveniently implemented in forms of a software package. Such a software package may be a computer program product which employs a non-transitory computer-readable storage medium including stored computer code which is used to program a computer to perform the disclosed functions and processes disclosed herein. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of operation of a proxy server, the method comprising:
receiving a client request for a data object;
checking if the requested data object has a corresponding entry in a tracking table associated with a cache controlled by the proxy server to determine if the requested data object is stored in the cache; and
when checking indicates that the requested data object does not have a corresponding entry in the tracking table, forwarding the client request to a remotely-located server.

2. The method of operation as claimed in claim 1, further comprising:
when checking indicates that the requested data object does have a corresponding entry in the tracking table, evaluating the entry to determine if the requested data object is stored in the cache.

3. The method of operation as claimed in claim 2, further comprising:
when evaluating the entry indicates that the requested data object is stored in the cache, retrieving the requested data object from the cache and transmitting the requested data object to the requesting client.

4. The method of operation as claimed in claim 3, further comprising:
when evaluating the entry indicates that the requested data object is not stored in the cache, forwarding the client request to the remotely-located server.

5. The method of operation as claimed in claim 4, further comprising:
when evaluating the entry indicates that the requested data object is not stored in the cache, and after the client request is forwarded to the remotely-located server, receiving a response from the remotely-located server, the response including the requested data object.

6. The method of operation as claimed in claim 5, further comprising:
when evaluating the entry indicates that the requested data object is not stored in the cache, and after the client request is forwarded to the remotely-located server, and after the requested data object is received from the remotely-located server, transmitting the requested data object to the requesting client.

7. The method of operation as claimed in claim 1, further comprising:
when checking indicates that the requested data object does not have a corresponding entry in the tracking table, and after forwarding the client request to the remotely-located server, receiving a response from the remotely-located server, the response including the requested data object.

8. The method of operation as claimed in claim 7, further comprising:
when checking indicates that the requested data object does not have a corresponding entry in the tracking table, and after forwarding the client request to the remotely-located server, and after receiving the response from the remotely-located server, transmitting the requested data object to the requesting client.

9. The method of operation as claimed in claim 1, further comprising:
updating the tracking table based upon the received client request.

10. A non-transitory computer-readable medium having computer-executable instructions for performing a method of operation of a proxy server, the method comprising:
receiving a client request for a data object;
checking if the requested data object has a corresponding entry in a tracking table associated with a cache controlled by the proxy server to determine if the requested data object is stored in the cache;
when checking indicates that the requested data object does not have a corresponding entry in the tracking table, forwarding the client request to a remotely-located server; and
when checking indicates that the requested data object does have a corresponding entry in the tracking table, evaluating the entry to determine if the requested data object is stored in the cache.

11. The non-transitory computer-readable medium as claimed in claim 10, the method further comprising:
when evaluating the entry indicates that the requested data object is stored in the cache, retrieving the requested data object from the cache and transmitting the requested data object to the requesting client.

12. The non-transitory computer-readable medium as claimed in claim 11, the method further comprising:
when evaluating the entry indicates that the requested data object is not stored in the cache, forwarding the client request to the remotely-located server.

13. The non-transitory computer-readable medium as claimed in claim 12, the method further comprising:
when evaluating the entry indicates that the requested data object is not stored in the cache, and after the client request is forwarded to the remotely-located server, receiving a response from the remotely-located server, the response including the requested data object.

14. The non-transitory computer-readable medium as claimed in claim 13, the method further comprising:
when evaluating the entry indicates that the requested data object is not stored in the cache, and after the client request is forwarded to the remotely-located server, and after the requested data object is received from the remotely-located server, transmitting the requested data object to the requesting client.

15. The non-transitory computer-readable medium as claimed in claim 10, the method further comprising:
when checking indicates that the requested data object does not have a corresponding entry in the tracking table, and after forwarding the client request to the remotely-located server, receiving a response from the remotely-located server, the response including the requested data object.

16. The non-transitory computer-readable medium as claimed in claim 15, the method further comprising:
when checking indicates that the requested data object does not have a corresponding entry in the tracking table, and after forwarding the client request to the remotely-located server, and after receiving the response from the remotely-located server, transmitting the requested data object to the requesting client.

17. The non-transitory computer-readable medium as claimed in claim 10, the method further comprising:
updating the tracking table based upon the received client request.

18. A proxy server, comprising:
a processor;
a memory, the memory being communicatively coupled with the processor; and
control programming communicatively coupled with the processor and memory, wherein the control programming causes the proxy server to perform the following steps:
receiving a client request for a data object;
checking if the requested data object has a corresponding entry in a tracking table associated with a cache controlled by the proxy server to determine if the requested data object is stored in the cache;
when checking indicates that the requested data object does not have a corresponding entry in the tracking table, forwarding the client request to a remotely-located server; and
when checking indicates that the requested data object does have a corresponding entry in the tracking table, evaluating the entry to determine if the requested data object is stored in the cache.

19. The proxy server as claimed in claim 18, wherein the control programming causes the proxy server to perform the further following steps:
when evaluating the entry indicates that the requested data object is stored in the cache, retrieving the requested data object from the cache and transmitting the requested data object to the requesting client; and
when evaluating the entry indicates that the requested data object is not stored in the cache, forwarding the client request to the remotely-located server, receiving a response from the remotely-located server, the response including the requested data object, and transmitting the requested data object to the requesting client.

20. The proxy server as claimed in claim 18, wherein the control programming causes the proxy server to perform the further following steps:
when checking indicates that the requested data object does not have a corresponding entry in the tracking table, and after forwarding the client request to the remotely-located server, receiving a response from the remotely-located server, the response including the requested data object, and after receiving the response from the remotely-located server, transmitting the requested data object to the requesting client.
